(19) United States
(12) Patent Application Publication
(10) Pub. No.: US 2013/0008076 A1
(43) Pub. Date: Jan. 10, 2013

(54) Fishing Hook Storage and Threading Device

(76) Inventor: Joyce Stenklyft, Tomah, WI (US)

(21) Appl. No.: 13/357,733

(22) Filed: Jan. 25, 2012

Related U.S. Application Data
(60) Provisional application No. 61/504,468, filed on Jul. 5, 2011.

(51) Int. Cl. A01K 97/00

(52) U.S. Cl. 43/44.83

(57) ABSTRACT

A fishing hook-threader device is provided for facilitating easy threading of fishing line through the eye of a fishing hook. The device has a needle threader, a hook retention portion and a buoyancy element. A plurality of hooks is hung by the fishing hook eyes along the hook retention portion where the hooks may be stored prior to use. When a user is ready to use a hook, it is separated from the plurality by sliding along the hook retention portion onto an indented hook separation region just prior to the needle threader. The needle threader is a hoop wire that permits fishing line to pass through an interior space and is suitably sized to promote ease of use by users with poor dexterity or low visual acuity. A buoyancy element is further secured to the hook retention portion to prevent the device from sinking if it falls into the water.

### CROSS REFERENCE TO RELATED APPLICATION

This application claims the benefit of U.S. Provisional Application No. 61/504,468 filed on Jul. 5, 2011, entitled “Kingfish Hook Threader.”

### BACKGROUND OF THE INVENTION

1. Field of the Invention

The present invention relates to a fishing accessory. More specifically, it relates to a fishing hook threading device that provides easy threading of fishing line through the eye of a hook. The device can also be used to retain a plurality of unthreaded hooks prior to their use and ease of engaging a fishing line with a single unit thereof. Fishers will find the invention useful for simplifying storage and preparation of fishing hooks prior to use.

Fishing enthusiasts utilize a wide range of environments and equipment when enjoying the sport of fishing. Some fishers enjoy fly-fishing in rivers. Others enjoy lake or ocean fishing from a boat. Still others prefer dock or pier fishing. Regardless of the place a fisher likes to drop his or her line, they generally must utilize fishing hooks in order to catch their prize. Many different types of hooks are utilized according to the environment fishing will occur in and the type of fish being caught. Commonly used hooks are J-shaped needles with a forked curved end and a needle eye along the upper end. Fishing line is threaded through the eye of the hook and tied off so that the hook may be attached to a fishing pole. With just a fishing pole, fishing line, bait and a fishing hook, a fisher is able to enjoy his or her hobby.

The most difficult part of preparing a fishing pole assembly for use is the threading of fishing hooks. Fishing line must be inserted through the eye of the hook, a motion similar to that of inserting thread through a needle for sewing. This preparatory activity can be extremely difficult in the dim lighting of dawn and dusk, which are the most commonly used fishing times. The task can be further complicated if a user has poor dexterity, low vision, or is in a boat on choppy waters. Under such conditions it becomes necessary for a fisher to use a hook-threading device to assist with insertion of fishing line through the eye of a fishing hook.

2. Description of the Prior Art

The present invention provides a fishing hook threading device that facilitates the easy threading of fishing line through the eye of a fishing hook. It provides orderly storage of fishing hooks along the length of the device and further includes a floatation bobber to reduce the risk that the device will sink if dropped into water. The prior art does not include devices offering these combined benefits to a user.

A number of fishing hook threading devices have been created to tackle the problem of preparing tackle for use. Many of these devices provide a simple wire threader secured to a handle. The wire threader may have the form of a diamond, triangle or other geometric shape. To use these devices a fisherman grips the handle in a first hand and a fishing hook in the other hand. The wire threader is then inserted through the eye of the fishing hook. Fishing line is threaded through the interior portion of the wire threader that is furthest from the device handle. The fishing hook is then removed from the wire threader, carrying the fishing line with it.

Examples of such devices are disclosed by Martin, U.S. Pat. No. 5,251,797, and Bukowski, U.S. Pat. No. 6,026,607. Another of these devices is disclosed by Samilov U.S. Pat. No. 4,102,478. Samilov describes a handle having a tubular inner portion that is slideably retained within a tubular outer portion, creating a handle. A wire threader is secured to the handle by trapping the ends of the threader between the inner and outer tubular portions. This structure provides a user with the capability of replacing the wire threader portion if it becomes broken.

Other fishing hook threaders provide stable positioning of a hook so that thread is inserted through the eye itself instead of through a wire loop. Ruzicka, U.S. Pat. No. 7,793,459 describes a hand held fishing hook threader that retains a single hook in a fixed position for threading. A tubular tunnel extends vertically through an area near the front of the device, and is connected thereto by a vertical slit running through the device and extending from the front of the device to the tubular tunnel. Centered in the front face of the device and bisecting the vertical slit, is a tubular aperture extending between the front face and the tubular tunnel. This aperture is adapted to receive and retain the eye and shaft of a fishing hook. When a hook is inserted into the aperture and pressed into position, the eye of the hook is visible through the vertical tubular tunnel. Thread is then inserted into the tubular tunnel and through the eye of the fishing hook. The threaded hook can be removed from the device by applying retrograde force, so that the fishing line slides through the vertical slit. While this device is an improvement over the use of just hands and eyes, it may still be difficult for users with shaky hands or poor vision to thread the hook. Devices that utilize a larger wire threader means, such as the present invention, provide a substantial threading area to overcome this problem. Users with poor motor coordination or visual acuity will find it simpler to insert thread into a wire threader than into the small tubular tunnel described by Ruzicka.

These prior art devices have several known drawbacks. None of these devices disclose a portion for retaining a plurality of fishhooks and a means to address a single hook from the plurality contained on the same tool. The present device addresses the failing of the prior art by providing a portion of the device that can retain several fishing hooks prior to threading, along with an indented hook separation region to separate a single hook prior to the threading operation. Furthermore, devices of this type that are described it the art fail to disclose a buoyancy element that reduces the likelihood that the device will sink if it falls into water. The present invention addresses this need by providing a device that can be rapidly deployed while in the fishing environment for swift threading of a new fishing hook prior to the attachment of bait. It is therefore submitted that the present invention substantially diverges in design elements from the prior art, and consequently it is clear that there is a need in the art for an improvement to existing fishing hook threading devices. In this regard the instant invention substantially fulfills these needs.

### SUMMARY OF THE INVENTION

In view of the foregoing disadvantages inherent in the known types of fishing hook threading devices now present in the prior art, the present invention provides a new hook storage means wherein the same can be utilized for providing convenience for the user when preparing fishing hooks for use or storing unused hooks in an organized manner prior to use.

The present fishing hook-threading device comprises a wire needle-threader, a hook retention portion and a buoyancy element. The wire needle-threader is a piece of wire formed in a hoop shape having an open interior, such that a fishing line can be easily inserted therethrough. The closed wire is easily collapsible onto itself such that it can be drawn through the eye of a needle. The wire needle-threader should have an uncompressed interior area that is sufficiently large to enable a user with poor vision or shaky hands to insert fishing line through the interior area, whereafter the threader hoop and fishing line are drawn through the eyelet of a fishing hook to connect the fishing line and the hook. This will also be useful to users fishing from boats subject to rough water conditions, environments with limited visibility, or any environment without suitable workspace to enable such intricate threading operations.

The hook retention portion is a tubular section secured to an end of the needle-threader. The hook retention portion is straight with at least one curved or kinked section at an end proximal to the wire needle-threader. Fishing hooks may be applied to the hook retention portion by insertion of the needle-threader through the eye of a fishing hook and then sliding the hook along the needle-threader and onto the hook retention portion. Hooks are retained along curved sections of the hook retention portion to reduce shifting or sliding of the hooks during transit.

At the end of the hook retention portion distal from the needle-threader is a buoyancy element. It may be formed in the shape of any three-dimensional geometric figure, though a sphere is used in preferred embodiments. This buoyancy element is made of a buoyant material such as Styrofoam or other industry accepted buoyant material. If the device should fall into water while the user is trying to thread a fishing hook, the buoyancy element will reduce the likelihood that the device will sink, thereby preserving the user's fishing hooks.

It is therefore an object of the present invention to provide a new and improved fishing hook threading device that has all of the advantages of the prior art and none of the disadvantages.

Another object of the present invention to provide a fishing hook threading device that offers visually substantial threading area to facilitate easy threading of fishing hooks by users with shaky hands, poor eyesight, and those in boats experiencing rough water conditions.

Another object of the present invention is to provide a fishing hook threading device having a storage means for orderly retention of fishing hooks that are not yet in use.

Yet another object of the present invention is to provide a fishing hook-threading device having a buoyancy element secured thereto, so as to prevent the loss of fishing hooks if the device should fall into water.

A still further object of the present invention is to provide a fishing hook threading device having resilient and durable construction that will permit the device to be carried about in a tackle box full of fishing tools without suffering substantial damage to the structural integrity of the device.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side view of the present fishing hook-threading device with a number of fishing hooks aligned along the hook-retention portion.

FIG. 2 shows a side view of a fishing hook in transition between the hook retention portion and the needle-threader along the indented hook separation region.

FIG. 3 shows a side view of the present fishing hook-threading device with a fishing hook in transition between the hook retention portion and the needle threader. Fishing line is inserted through the interior space of the needle threader.

FIG. 4 shows a side view of the present fishing hook-threading device in use. A fishing hook is being removed from the device after thread is inserted into the needle threader, resulting in the threading of the fishing hook.

### DETAILED DESCRIPTION OF THE INVENTION

Reference is made herein to the attached drawings. Like reference numerals are used throughout the drawings to depict like or similar elements of the fishing hook threading device. For the purposes of presenting a brief and clear description of the present invention, the preferred embodiment will be discussed as used for facilitating the insertion of fishing line through the eye of a fishing hook. The figures are intended for representative purposes only and should not be considered to be limiting in any respect.

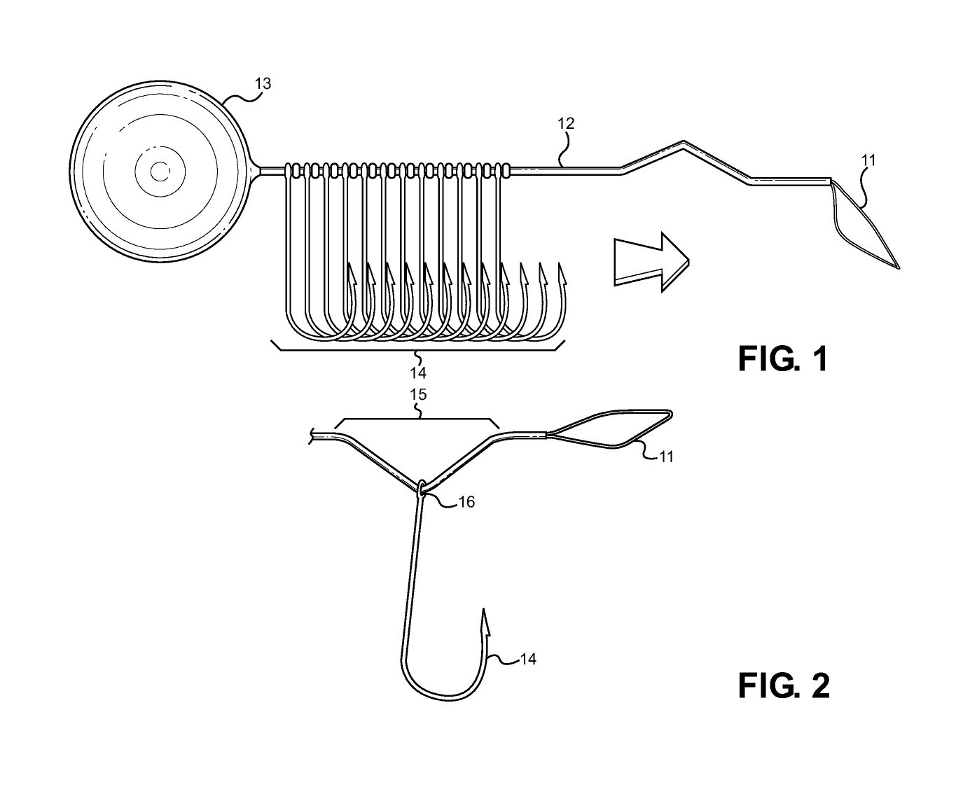

Referring now to FIG. 1, there is shown a side view of the present fishing hook-threading device. The present invention comprises a needle threader element 11, a hook retention portion 12 and a buoyancy element 13. The needle threader 11 is secured to a first end of the hook retention portion 12 and a buoyancy element 13 is secured to a second end of the same. A plurality of fishing hooks 14 is slideably secured along the hook retention portion 12, which is inserted through the eyes of the fishing hooks. The hook retention portion 12 is tubular to facilitate sliding of hooks along the length of the hook retention portion. Removably securing hooks in this manner reduces the number of loose hooks scattered about a user's tackle box, improves hook organization and prevents searching or being stabbed inadvertently therefrom.

The buoyancy element 13 is a small bobber secured to an end of the hook retention portion 12. Buoyant bobbers are well known in the art of fishing tackle and it should be understood that any buoyant material or shape used in the art may be utilized in the construction of the buoyancy element to prevent the device from sinking when placed into a body of water. In a preferred embodiment, the buoyancy element is a spherical bobber that facilitates a user's grip on the device during operation thereof. This element will be appreciated by fisherman engaging in fishing from a boat or floating dock, or who are otherwise subjected to rough conditions that increase the likelihood that tackle will be dropped into the water. If the fishing hook-threading device is dropped into water, the buoyancy element will remain afloat, preventing the secured fishing hooks from sinking and loss of the device. To further promote ease of reclaiming a device that has fallen into the water, the bobber may be painted in bright colors or patterns for increased visibility.

Referring now to FIG. 2, there is shown a side view of a fishing hook 14 being prepared for threading. The hook retention portion 12 has an indented hook separation region 15 that is a non-linear projection or indentation along the portion 12 length. This region is located along the hook retention portion 12 just prior to the needle threader element 11. Fishing hooks stored along the straight section of the hook retention portion are prevented from falling off the device by the angled or curved non-linear segment, and the indentation facilitates the separation of a single hook from the group. The eyes of stored fishing hooks can not slide easily along the segment and thus are limited to the segment of the hook retention portion proximal to the buoyancy element (see FIG. 1). This non-linear segment may be kinked, curved, sinuate, zigzagged or the like. When a user is ready to thread a fishing hook, he or she may slide it along the hook retention portion and gently work the eye of the hook to the hook separation region, wherein the device is rotated to create a valley for easy placement of a singular hook in the separation region. After the hook passes over the kink 16 in this region, the device can be rotated another 180 degrees to create an upstanding hill that resists the rest of the stored hooks from crossing the hook separation region 15.

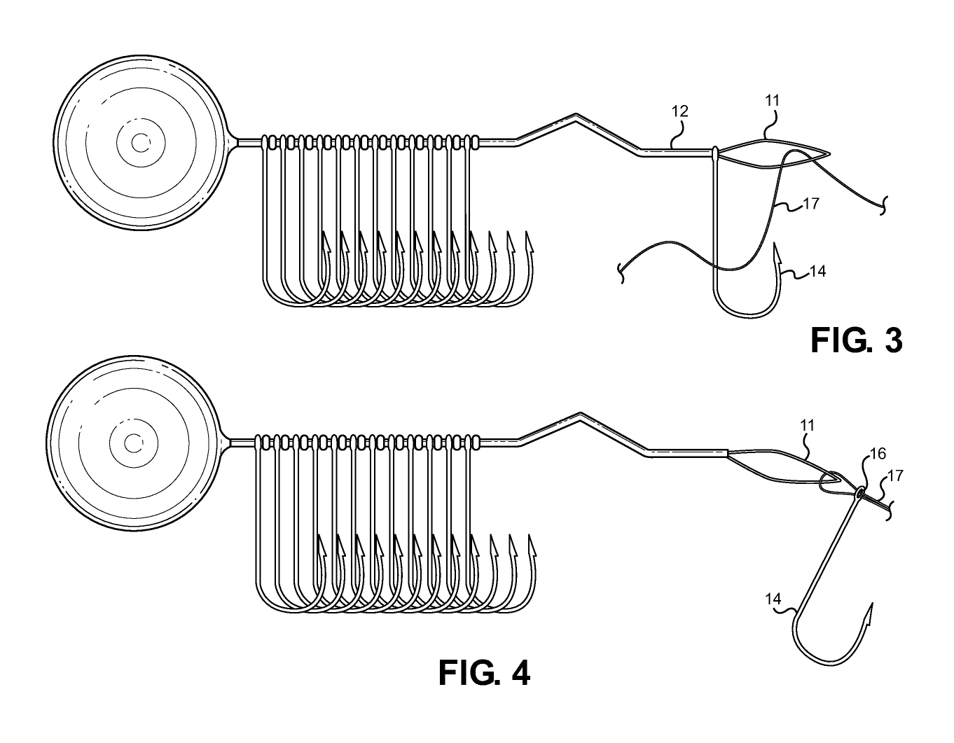

Referring now to FIG. 3 there is shown a side view of the device with fishing line 17 inserted through the needle threader element 11. The needle threader is a small gauge wire formed into a closed geometric shape and secured to an end of the hook retention portion 12. Fishing line is inserted through the interior space created by the shaped wire. The size of the interior space should be significant enough to permit users to easily insert the end of a fishing line into the space without the assistance of additional tools. Rough water conditions, lack of dexterity or poor eyesight may make it difficult for some users to perform this task if the needle threader is too small. The needle threader is deformable and has a compressed and uncompressed state. This compression is essential to permit hooks to pass over the needle threader during the threading process. A diamond or triangular shape is utilized in the preferred embodiment because the angles provided by these shapes may be easily inserted through the eye of a needle. This functionality allows hooks to be inserted onto the device as well as removed. In alternative embodiments the geometric shape may be ovular, circular or any other suitable shape.

Referring now to FIG. 4 there is shown a side view of the device with a threaded fishing hook 14 being removed from the needle threader 11. The needle threader is deformable due to the small gauge wire used in construction. When fishing line is inserted the needle threader is expanded into an uncompressed state by a user, as in FIG. 3. After fishing line is inserted through the needle threader, the eye of a fishing hook 16 is gently slid across the needle threader element. The shape of the needle threader compresses to permit the fishing hook to pass over it. Once the fishing hook is removed from the device, pulling action is continued until the fishing line is removed from the needle threader. The gauge and type of wire used will determine whether the needle threader experiences expansion to the uncompressed state or remains compressed until manually expanded by a user.

In use an individual inserts a piece of fishing line through the interior space of the needle threader element. The user then carefully slides one of the stored fishhooks across the hook retention portion to the needle threader. This involves the guidance of the fishing hook across the non-linear segment of the hook retention portion. A user then slides the fishing hook over the needle threader and the fishing line. As the hook is pulled away from the device the fishing line is retained within the eye of the hook. The user then pulls one end of the fishing line out of the eye of the hook and out of the needle threader, leaving the fishing hook threaded and ready for use.

The present invention is a fishing accessory that is designed to improve speed and ease of preparing fishing hooks for use. Fishermen on land and sea alike will appreciate the reduced complexity of threading fishing line through the eye of a fishing hook. They will also appreciate the hook retention portion, which facilitates compact and orderly storage of fishing hooks and reduces clutter within a tackle box by reducing the number of loose hooks strewn about the box. Further benefit is provided by the buoyancy element, which acts as a floatation bobber and reduces the chance that the device will sink if plunged into water. Thus, the device provides a user with a compact means for retaining fishing hooks that are not in use, threading hooks in preparation for use, §preventing hooks from being lost if they should fall into water, and a means for reducing clutter in a tackle box.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A fishing hook threading device, comprising:
a needle threader element;
a buoyancy element;
an elongated hook retention portion having a first and second end;
said hook retention portion having a hook separation region adapted to isolate a single hook near said first end;
said needle threader element being secured to said hook retention portion first end and said buoyancy element being secured to said hook retention portion second end.

2. The device of claim 1, wherein said needle threader element is a closed shape adapted to easily accept a fishing line, collapse and be drawn through a hook eyelet.

3. The device of claim 1, wherein said needle threader element is constructed of wire.

4. The device of claim 1, wherein said buoyancy element is s geometric figure.

5. The device of claim 1, wherein said buoyancy element is spherical.

6. The device of claim 1, wherein said hook retention portion is tubular and elongated to provide hook eyelet engagement to store a plurality of fishing hooks thereon.

7. The device of claim 1, wherein said hook separation region is a non-linear segment along said elongated hook retention portion that provides a kink to isolate a single hook eyelet.
